(19) United States
(12) Patent Application Publication
(10) Pub. No.: US 2006/0132437 A1
(43) Pub. Date: Jun. 22, 2006

(54) Display apparatus

(75) Inventor: Young-chan Kim, Uiwang-si (KR)

Correspondence Address: ROYLANCE, ABRAMS, BERDO & GOODMAN, L.L.P., 1300 19TH STREET, N.W., SUITE 600, WASHINGTON,, DC, 20036, US

(73) Assignee: Samsung Electronics Co., Ltd.

(21) Appl. No.: 11/280,443

(22) Filed: Nov. 17, 2005

(30) Foreign Application Priority Data
Dec. 20, 2004 (KR) 10-2004-0108896

(51) Int. Cl. G09G 5/08

(52) U.S. Cl. 345/157

(57) ABSTRACT

A display apparatus for communicating with a computer main body through a DPVL system, wherein the display apparatus is provided with a video signal processor to process a video signal output from a computer main body into a displayable video signal, a frame buffer to store frame information corresponding to the video signal, and a controller to control the video signal processor to display a picture based on the frame information stored in the frame buffer when a predetermined shutdown signal is output from the computer main body, and change the picture on the basis of the stored frame information when a predetermined period has elapsed after receiving the shutdown signal. Thus, the present invention provides a display apparatus in which an image sticking phenomenon is decreased, wasteful power consumption is reduced, and which can prevent a user from being confused while the display apparatus continuously displays a still picture.

### CROSS-REFERENCE TO RELATED APPLICATIONS

This application claims the benefit under 35 U.S.C. §119(a) of Korean Patent Application No. 10-2004-0108896, filed in the Korean Intellectual Property Office on Dec. 20, 2004, the entire disclosure of which is incorporated herein by reference.

### BACKGROUND OF THE INVENTION

1. Field of the Invention

The present invention relates to a display apparatus for supporting a digital packet video link (DPVL) system. More particularly, the present invention relates to a display apparatus which can decrease an image sticking phenomenon arising in a shutdown state when displaying a still picture as a shutdown signal is transmitted from a computer main body to the display apparatus. The present invention can further reduce wasteful power consumption, and offer various messages to prevent a user from being confused as to the operation being performed.

2. Description of the Related Art

In conventional computer systems, a digital packet video link (DPVL) is often employed in a communication system between a computer main body and a display apparatus so as to improve limited transmission speed in transmitting a large amount of high resolution video data to the display apparatus.

When the video data is transmitted from the computer main body that supports the DPVL system to the display apparatus, the computer main body recognizes a changed part of the current video data from the previous video data, and makes packet data for only the changed part of the current video data. The computer main body can then transmit the packet data to the display apparatus. Therefore, the display apparatus displays a picture, and partially changes the picture only when the changes correspond to the received packet data. Thus, the transmission speed that is limited due to the large amount of video data can be improved.

When the computer main body supporting the DPVL system enters a link shutdown state, power saving mode or power-off state, the computer main body outputs a shutdown signal to the display apparatus. When the conventional display apparatus receives the shutdown signal, the display apparatus continuously displays a picture corresponding to the immediately preceding video data stored in a frame buffer, thereby providing a user with a still picture.

However, such a conventional display apparatus supporting the DPVL communication system continuously displays the still picture when it receives the shutdown signal from the computer main body, such that any number of operation problems can arise. For example, an image sticking (or afterimage) phenomenon can arise, thereby deteriorating picture quality of the display apparatus. Further, even though there is no video data transmitted from the computer main body, the display apparatus continuously operates, thereby wastefully consuming power. Also, in the case where the conventional display apparatus supporting the DPVL communication system continuously displays the still picture in response to the shutdown signal, it is difficult for a user to distinguish whether the display apparatus is displaying the still picture due to continuously receiving the same video data from the computer main body, or due to receiving the video data stored in the frame buffer without receiving the video data from the computer main body in response to the shutdown signal.

Accordingly, a need exists for a display apparatus and control method in which the aforementioned image sticking phenomenon is decreased, wasteful power consumption is reduced, and which can prevent a user from being confused while the display apparatus continuously displays a still picture.

### SUMMARY OF THE INVENTION

Accordingly, it is an aspect of the present invention to provide a display apparatus in which an image sticking phenomenon is decreased while the display apparatus continuously displays a still picture in response to a shutdown signal transmitted from a computer main body.

Another aspect of the present invention is to provide a display apparatus in which wasteful power consumption is reduced while the display apparatus continuously displays a still picture in response to a shutdown signal transmitted from a computer main body.

Still another aspect of the present invention is to provide a display apparatus which can prevent a user from being confused as to the operation being performed while the display apparatus continuously displays a still picture in response to a shutdown signal transmitted from a computer main body.

Additional aspects and advantages of the present invention will be set forth, in part in the description which follows and, in part will be obvious from the description, or may be learned by practice of the present invention.

The foregoing and other aspects of the present invention are also achieved by providing a display apparatus for communicating with a computer main body through a DPVL system, wherein the display apparatus comprises a video signal processor to process a video signal output from a computer main body into a displayable video signal, a frame buffer to store frame information corresponding to the video signal, and a controller to control the video signal processor to display a picture based on the frame information stored in the frame buffer when a predetermined shutdown signal is output from the computer main body, and change the picture on the basis of the stored frame information when a predetermined period has elapsed after receiving the shutdown signal.

According to an aspect of the present invention, the controller controls the video signal processor to display the picture based on the frame information stored in the frame buffer when the predetermined shutdown signal is output from the computer main body, and move the picture by a predetermined width or distance when a predetermined period has elapsed after receiving the shutdown signal.

According to an aspect of the present invention, the display apparatus further comprises a key input part to allow a user to input a key, and an on screen display (OSD) generator to generate a position movement menu allowing a user to select a position movement function for the picture to be turned on and off, and to further allow a user to set the predetermined period for implementing the position movement function. The controller controls the OSD generator to display the position movement menu when the position movement function is selected through the key input part, and store setting information that is set through the position movement menu by manipulating the key input part.

According to an aspect of the present invention, the controller controls the video signal processor to move the position of the displayed picture by a predetermined width or distance after a lapse of the predetermined period, count the predetermined period, and then move the position of the displayed picture again after a lapse of the predetermined period.

According to an aspect of the present invention, the controller controls the video signal processor to display the picture based on the frame information stored in the frame buffer when the shutdown signal is input, and blink the displayed picture per a predetermined cycle after the predetermined period has elapsed.

The foregoing and other aspects of the present invention are also achieved by providing a display apparatus for communicating with a computer main body through a DPVL system, wherein the display apparatus comprises a video signal processor to process a video signal output from a computer main body into a displayable video signal, a frame buffer to store frame information corresponding to the video signal, and a power supply to supply power to various circuits provided in the display apparatus. The display apparatus further comprises a controller to control the video signal processor to display a picture based on the frame information stored in the frame buffer when a predetermined shutdown signal is output from the computer main body, and control the power supply to interrupt the power supplied to the apparatus circuits and thus, direct the display apparatus to enter a power saving mode when a predetermined period has elapsed after receiving the shutdown signal.

According to an aspect of the present invention, the display apparatus further comprises a key input part to allow a user to input a key, and an OSD generator to generate a power saving function menu for allowing a user to select the power saving mode to be turned on and off, and further allows a user to set the predetermined period for implementing the power saving mode. The controller controls the OSD generator to display the power saving function menu when the power saving mode is selected through the key input part, and store setting information that is set through the power saving function menu by manipulating the key input part.

According to an aspect of the present invention, the OSD generator generates a message to indicate whether the display apparatus is in the shutdown state and inform a user of the time since entering the shutdown state, or the time until entering the power saving mode. The controller controls the OSD generator to display the message when a current state of the display apparatus is asked about by a user through the key input part while the display apparatus receives the shutdown signal and thus, displays the picture based on the frame information stored in the frame buffer.

The foregoing and other aspects of the present invention are also achieved by providing a display apparatus for communicating with a computer main body through a DPVL system, wherein the display apparatus comprises a video signal processor to process a video signal output from a computer main body into a displayable video signal, a frame buffer to store frame information corresponding to the video signal, an OSD generator to generate a shutdown message to indicate a shutdown state, and a key input part to allow a user to input a key. The display apparatus further comprises a controller to control the OSD generator to display the shutdown message when a current state of the display apparatus is asked about by a user through the key input part while the display apparatus receives the shutdown signal from the computer main body and thus, displays a picture based on the frame information stored in the frame buffer.

According to an aspect of the present invention, the OSD generator generates a shutdown entering message to indicate entering the shutdown state, and the controller controls the OSD generator to display the shutdown entering message for a predetermined period of time when the shutdown signal is output from the computer main body.

### BRIEF DESCRIPTION OF THE DRAWINGS

The above and other aspects and advantages of the present invention will become apparent and more readily appreciated from the following description of the embodiments, taken in conjunction with the accompany drawings, of which:

FIG. 1 is a control block diagram of a display apparatus according to a first embodiment of the present invention;

FIG. 2 is a control flowchart of the display apparatus according to the first embodiment of the present invention;

FIG. 3 is a control block diagram of a display apparatus according to a second embodiment of the present invention;

FIG. 4 is a control flowchart of the display apparatus according to the second embodiment of the present invention;

FIG. 5 is a control block diagram of a display apparatus according to a third embodiment of the present invention; and

FIG. 6 is a control flowchart of the display apparatus according to the third embodiment of the present invention.

Throughout the drawings, like reference numerals will be understood to refer to like parts, components and structures.

### DETAILED DESCRIPTION OF THE EXEMPLARY EMBODIMENTS

Reference will now be made in greater detail to embodiments of the present invention, examples of which are illustrated in the accompanying drawings, wherein like reference numerals refer to like elements throughout.

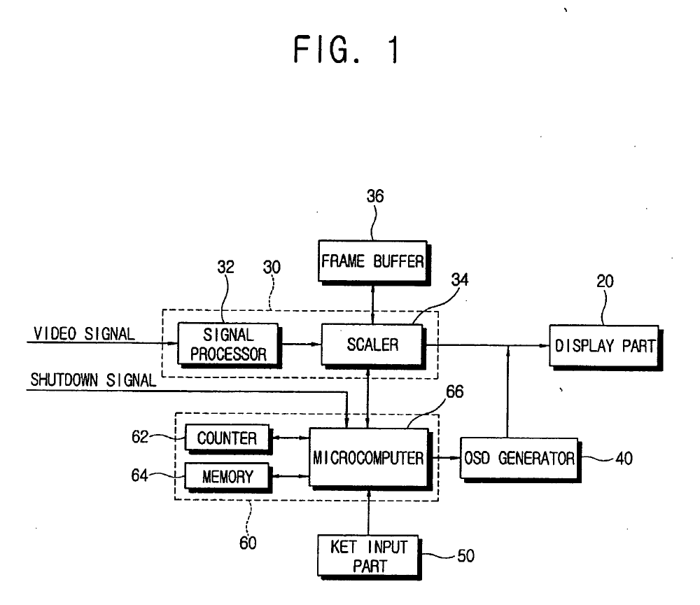

FIG. 1 is a control block diagram of a display apparatus according to a first embodiment of the present invention. As shown therein, a display apparatus according to the first embodiment of the present invention comprises a display part 20, a frame buffer 36 to store frame information corresponding to a video signal, and a video signal processor 30 that is controlled by a controller 60 to process the video signal transmitted from a computer main body (not shown) on the basis of the frame information stored in the frame buffer 36 so as to be displayed on the display part 20. The display apparatus further comprises a key input part 50 to allow a user to input a key, an on screen display (OSD) generator 40 to generate a position movement menu, and a controller 60 to control the video signal processor 30 to display a picture based on the frame information stored in the frame buffer 36 when a predetermined shutdown signal is input from the computer main body, and to change the picture on the basis of the stored frame information after a lapse of a predetermined period from the time when the shutdown signal is input.

The video signal processor 30 comprises a scaler 34 to scale the video signal, and a signal processor 32 to convert an input video signal to be processed by the scaler 34. Here, the computer main body communicates with the display apparatus through a digital connection port (not shown). Further, the signal processor 32 comprises a transition minimized differential signaling (TMDS) receiver (not shown) to divide a digital video signal, such as a digital video interface (DVI) signal or the like that is input from the computer main body through the digital connection port, into red, green and blue (RGB) digital signals and horizontal/vertical synchronization signals, and output the signals to the scaler 34.

The scaler 34 converts the video signal output from the signal processor 32 into a video signal having a format suitable for the display part 20. Here, the scaler 34 also moves a display pixel of a picture that is displayed under the control of the controller 60, by a predetermined width or distance on the basis of the frame information of a picture stored in the frame buffer 36. Thus, the scaler 34 minutely moves and displays a picture. Further, the scaler 34 can allow a picture that is displayed under the control of the controller 60 to blink.

The key input part 50 allows a user to input a key. Here, the key input part 50 comprises an operation key (not shown) mounted to a main casing of the display apparatus with a wire-based configuration, and a remote controller (not shown) for allowing a user to wirelessly control the display apparatus at a long distance.

The OSD generator 40 generates the position movement menu for allowing a user to selectively turn on and off a position movement function for a picture, and further allows a user to set a predetermined period during which the position movement function is implemented, and outputs the position movement menu to the display part 20.

The controller 60 comprises a counter 62 to count an elapsed time, a memory 64 to store a predetermined setting value, and a microcomputer 66 to control the scaler 34 to display a picture based on the frame information stored in the frame buffer 36 when the shutdown signal is output from the computer main body, and change a picture on the basis of the stored frame information after a lapse of a predetermined period from the time when the shutdown signal is input.

The microcomputer 66 controls the OSD generator 40 to display the position movement menu when the position movement function is selected through the key input part 50. Further, the microcomputer 66 controls the memory 64 to store an on setting value when a position movement function for the picture is set to an on state through the position movement menu as the key input part 50 is manipulated, and controls the memory 64 to also store time information input through the position movement menu.

Here, when the shutdown signal is output from the computer main body, the microcomputer 66 checks the on setting value stored in the memory 64, controls the scaler 34 to continuously display a picture based on the frame information stored in the frame buffer 36, and controls the counter 62 to count an elapsed time.

At this time, the computer main body enters a link shutdown state, power saving mode, or power-off state, and does not transmit the video signal to the display apparatus. Accordingly, the display apparatus is also in a shutdown state, during which, a still picture is displayed on the basis of the frame information stored in the frame buffer 36.

Here, when the shutdown signal is input to the display apparatus on the basis of the time information of the memory 64, and a predetermined setting time (e.g., 20 minutes) based on the time information has elapsed, the microcomputer 66 controls the scaler 34 to minutely move the picture on the basis of the stored frame information. At this time, the microcomputer 66 controls the scaler 34 to move the picture and at the same time, initializes the counter 62 to re-count an elapsed time. After a lapse of the setting time (e.g., 20 minutes), the microcomputer 66 controls the scaler 34 to again minutely move the picture.

Therefore, the picture is not displayed as a still picture on the same pixel for a long period of time in the shutdown state. Accordingly, there is no afterimage due to the still picture even though a new picture is not displayed, thereby preventing a sticking phenomenon from arising.

Alternatively, when the shutdown signal is input and the setting time (e.g., 20 minutes) has elapsed, the microcomputer 66 may control the scaler 34 to blink a displayed picture per a predetermined cycle instead of controlling the scaler 34 to move the picture, thereby preventing the sticking phenomenon. Preferably, the cycle is only as short as that required to ensure that a user is not confused as to the operation being performed.

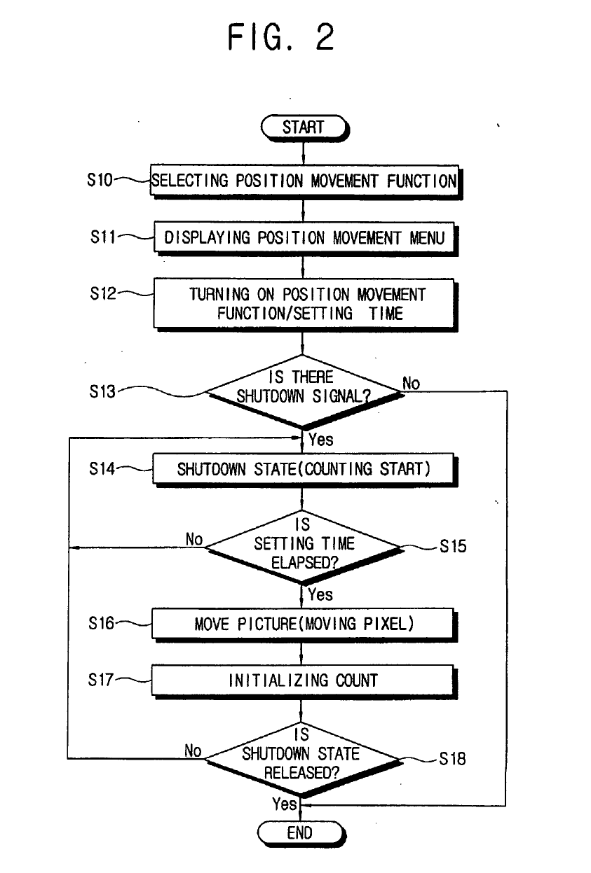

Hereinbelow, a control flowchart of the display apparatus according to the first embodiment of the present invention will be described with reference to FIG. 2. At operation S10, a user selects the position movement function. Accordingly, at operation S11, the microcomputer 66 controls the OSD generator 40 to display the position movement menu. At operation S12, when a user sets the position movement function to the on state through the position movement menu and inputs the time, the microcomputer 66 controls the memory 64 to store the on setting value and the set time information.

At operation S13, the microcomputer 66 determines whether the shutdown signal is output from the computer main body. In the case wherein the shutdown signal is output from the computer main body, the display apparatus enters the shutdown state at operation S14, during which, the microcomputer 66 controls the scaler 34 to display a still picture based on the frame information stored in the frame buffer 36. At this time, the microcomputer 66 controls the counter 62 to count the lapsed time. At operation S15, the microcomputer 66 determines whether the setting time (e.g., 20 minutes) based on the time information stored in the memory 64 has elapsed.

When it is determined that the setting time has elapsed, the microcomputer 66 controls the scaler 34 to minutely move the picture on the basis of the stored frame information at operation S16. At operation S17, the microcomputer 66 initializes the counter 62, and at operation S18, determines whether the shutdown state has been released by receiving the video signal output from the computer main body. In the case where the shutdown state is maintained, the microcomputer 66 returns to the operation S14.

Thus, the same video data is not displayed on the same pixel for a long period of time so that there is no afterimage, thereby preventing the sticking phenomenon from arising.

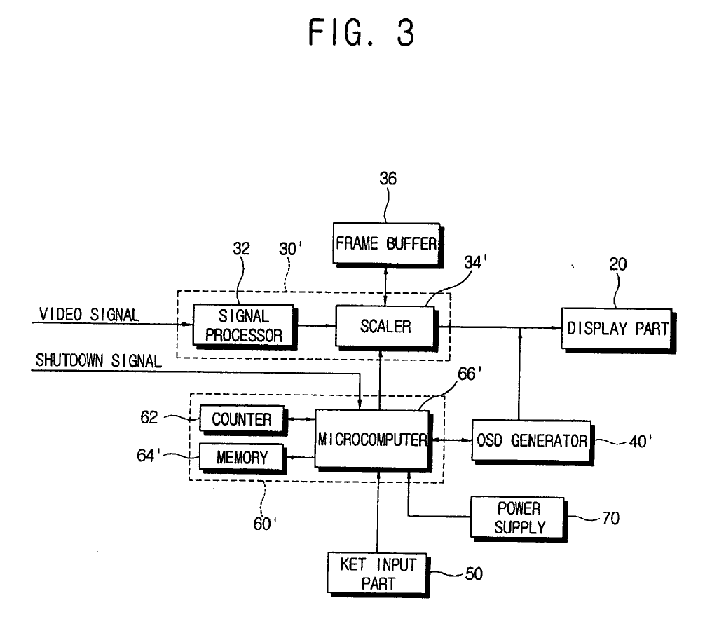

FIG. 3 is a control block diagram of a display apparatus according to a second embodiment of the present invention. As shown therein, a display apparatus according to the second embodiment of the present invention comprises the display part 20, the frame buffer 36 to store frame information corresponding to a video signal, and a video signal processor 30′ that is controlled by a controller 60′ to process the video signal transmitted from a computer main body (not shown) on the basis of the frame information stored in the frame buffer 36 so as to be displayed on the display part 20. The display apparatus further comprises the key input part 50 to allow a user to input a key, a power supply 70 to supply power to various circuits provided in the display apparatus, an on screen display (OSD) generator 40′ to generate a power saving function menu and a predetermined message, and the controller 60′ to control the video signal processor 30′ to display a picture based on the frame information stored in the frame buffer 36 when a predetermined shutdown signal is output from the computer main body, and to further control the power supply 70 to enter a power saving mode after a lapse of a predetermined period from the time when the shutdown signal is input.

Hereinafter, elements and descriptions which are substantially the same with regard to the first embodiment will be omitted for clarity and conciseness.

A scaler 34′ converts the video signal output from the signal processor 32 into a video signal having a format suitable for the display part 20.

The OSD generator 40′ generates a power saving function menu for allowing a user to turn on and off a power saving mode, set a period for implementing the power saving mode, and set a predetermined message to indicate whether the display apparatus is in the shutdown state and to indicate time remaining before entering the power saving mode. The OSD generator 40′ then outputs the power saving function menu and the predetermined message to the display part 20.

The controller 60′ comprises the counter 62 to count an elapsed time, a memory 64′ to store a predetermined setting value, and a microcomputer 66′ to control the scaler 34′ to display a picture based on the frame information stored in the frame buffer 36 when the shutdown signal is output from the computer main body, and controls the power supply 70 to interrupt the power being supplied to various circuits provided in the display apparatus after a lapse of a predetermined period from the time when the shutdown signal is input.

The microcomputer 66′ controls the OSD generator 40′ to display the power saving function menu when a power saving mode is selected through the key input part 50. Further, the microcomputer 66′ controls the memory 64′ to store an on setting value when the power saving mode is set to an on state through the power saving mode as the key input part 50 is manipulated, and controls the memory 64′ to also store time information input through the power saving function menu.

Here, when the shutdown signal is output from the computer main body, the microcomputer 66′ controls the scaler 34′ to continuously display a picture based on the frame information stored in the frame buffer 36, and controls the counter 62 to count an elapsed time. At this time, the computer main body enters a link shutdown state, power saving mode, or power-off state, and does not transmit the video signal to the display apparatus. Accordingly, the display apparatus is also in a shutdown state, during which, a still picture is displayed on the basis of the frame information stored in the frame buffer 36.

Here, when a user asks about a current state of the display apparatus through the key input part 50, the microcomputer 66′ controls the OSD generator 40′ to display a message to inform the user that the display apparatus displays the still picture while in the shutdown state, and further displays a message to inform the user how much time is remaining until the display apparatus enters the power saving mode on the basis of the counted time of the counter 62. Further, the microcomputer 66′ controls the power supply 70 to enter the power saving mode when the shutdown signal is input on the basis of the time information of the memory 64′ and when the setting time (e.g., 30 minutes) has elapsed.

Therefore, while the display apparatus displays the still picture based on the frame information of the frame buffer 36 as it receives the shutdown signal from the computer main body, the display apparatus displays a corresponding message when a user asks about the current state of the display apparatus, thereby preventing a user from being confused as to the operation being performed. At the same time, the display apparatus enters the power saving mode, thereby reducing wasteful power consumption.

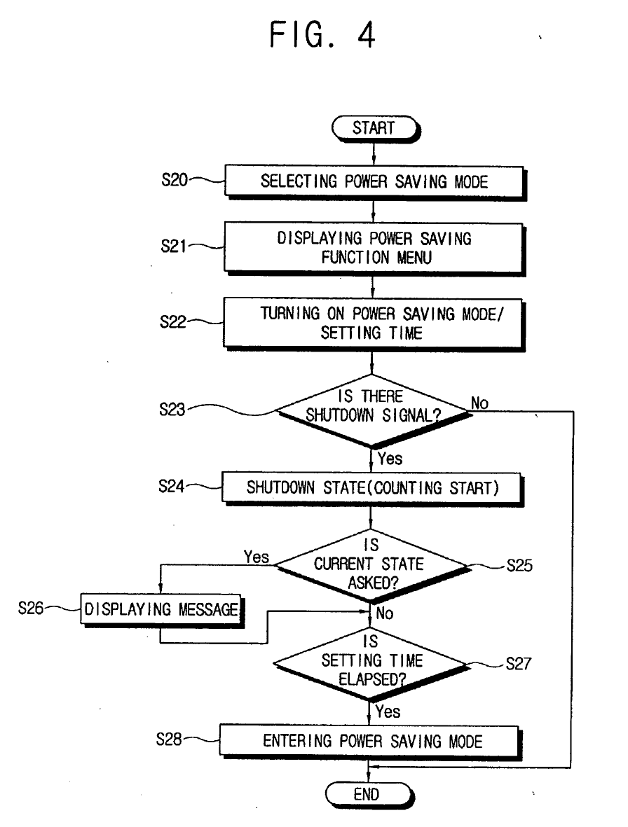

Hereinbelow, a control flowchart of the display apparatus according to the second embodiment of the present invention will be described with reference to FIG. 4. At operation S20, a user selects the power saving mode. Accordingly, at operation S21, the microcomputer 66′ controls the OSD generator 40′ to display the power saving function menu. At operation S22, when a user sets the power saving mode to the on state through the power saving function menu and inputs the time, the microcomputer 66′ controls the memory 64′ to store the on setting value and the set time information.

At operation S23, the microcomputer 66′ determines whether the shutdown signal is output from the computer main body. In the case wherein the shutdown signal is output from the computer main body, the display apparatus enters the shutdown state at operation S24, during which, the microcomputer 66′ controls the scaler 34′ to display a still picture based on the frame information stored in the frame buffer 36. At this time, the microcomputer 66′ controls the counter 62 to count the lapsed time.

At operation S25, the microcomputer 66′ determines whether a user asks about the current state by manipulating the key input part 50. When it is determined that a user asks about the current state by manipulating the key input part 50, the microcomputer 66′ controls the OSD generator 40′ to display the message at operation S26. After the message is displayed or when it is determined that a user does not ask about the current state through the key input part 50, the method moves to operation S27. At operation S27, when the setting time (e.g., 30 minutes) based on the time information stored in the memory 64′ has elapsed after performing the operations S25 or S26, the microcomputer 66′ controls the power supply 70 to enter the power saving mode at operation S28.

Thus, while the display apparatus receives the shutdown signal from the computer main body and displays the still picture based on the frame information of the frame buffer 36, the display apparatus displays the corresponding message when a user asks about the current state of the display apparatus in order to prevent a user from being confused as to the operation being performed, and then enters the power saving mode in order to reduce wasteful power consumption.

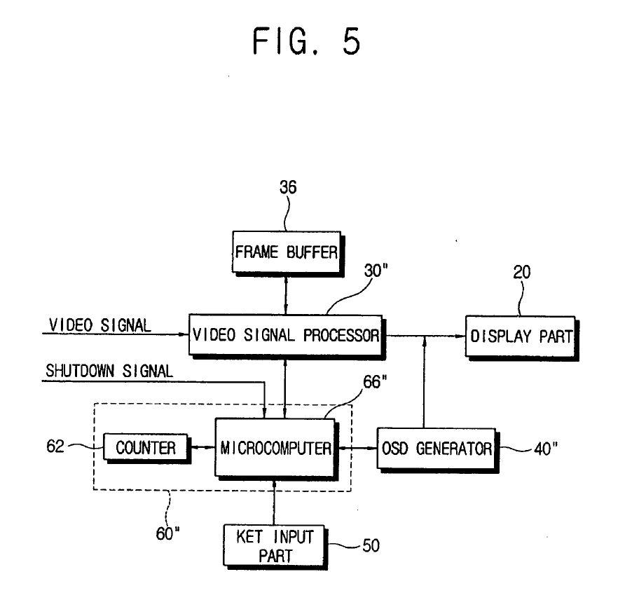

FIG. 5 is a control block diagram of a display apparatus according to a third embodiment of the present invention. As shown therein, a display apparatus according to the third embodiment of the present invention comprises the display part 20, the frame buffer 36 to store frame information corresponding to a video signal, and a video signal processor 30″ that is controlled by a controller 60″ to process the video signal transmitted from a computer main body (not shown) on the basis of the frame information stored in the frame buffer 36 so as to be displayed on the display part 20. The display apparatus further comprises the key input part 50 to allow a user to input a key, an on screen display (OSD) generator 40″ to generate a shutdown message to indicate a shutdown state and a shutdown entering message to indicate entering the shutdown state, and the controller 60″ to control the video signal processor 30″ to display a picture based on the frame information stored in the frame buffer 36 when a predetermined shutdown signal is output from the computer main body.

Hereinafter, elements and descriptions which are substantially the same with regard to the first and second embodiments will be omitted for clarity and conciseness.

The video signal processor 30″ comprises a scaler (not shown) to scale the video signal, and a signal processor (not shown) to convert an input video signal to be processed by the scaler. Here, the computer main body communicates with the display apparatus through a digital connection port (not shown). Further, the signal processor comprises a transition minimized differential signaling (TMDS) receiver (not shown) to divide a digital video signal, such as a digital video interface (DVI) signal or the like that is input from the computer main body through the digital connection port, into red, green and blue (RGB) digital signals and horizontal/vertical synchronization signals, and to then output the signals to the scaler.

The OSD generator 40″ generates the shutdown message to indicate that the display apparatus is in the shutdown state, during which the display apparatus displays the still picture, and the shutdown entering message to indicate that the display apparatus is entering the shutdown state, and outputs each to the display part 20.

The controller 60″ comprises the counter 62 to count an elapsed time, and a microcomputer 66″ to control the video signal processor 30″ to display a picture based on the frame information stored in the frame buffer 36 when the shutdown signal is output from the computer main body.

The microcomputer 66″ controls the video signal processor 30″ to display a picture based on the frame information stored in the frame buffer 36 when the shutdown signal is output from the computer main body, and controls the counter 62 to count an elapsed time. At this time, the computer main body enters a link shutdown state, power saving mode, or power-off state, and does not transmit the video signal to the display apparatus. Accordingly, the display apparatus is also in a shutdown state, during which a still picture is displayed on the basis of the frame information stored in the frame buffer 36.

At this time, when the display apparatus receives the shutdown signal from the computer main body and enters the shutdown state, the microcomputer 66″ controls the OSD generator 40″ to display the shutdown entering message to indicate that the display apparatus is entering the shutdown state. Preferably, the shutdown entering message disappears after a lapse of a predetermined period. After the shutdown entering message disappears, the display apparatus displays the still picture and the microcomputer 66″ controls the OSD generator 40″ to display the shutdown message to indicate to the user that the display apparatus is in the shutdown state if the user asks about the current state through the key input part 50. Preferably, the shutdown message may include the time (e.g., 1:05) that has elapsed after the display apparatus entered the shutdown state.

Thus, the display apparatus according to the third embodiment of the present invention displays the shutdown entering message when it receives the shutdown signal from the computer main body and enters the shutdown state, during which the still picture is displayed on the basis of the frame information stored in the frame buffer 36. Thereafter, when a user asks about the current state of the display apparatus, the display apparatus displays the shutdown message, thereby preventing a user from being confused about the operation being performed.

According to the third embodiment of the present invention, the display apparatus has a structure to prevent a user from being confused while the display apparatus receives the shutdown signal from the computer main body and is in the shutdown state. However, the display apparatus is not limited to the foregoing structure. Alternatively, in yet other embodiments of the present invention, the display apparatus may further comprise the power supply 70 like that of the second embodiment, and thus enter a power saving mode when a predetermined period has elapsed from the time when the shutdown state is started, thereby reducing wasteful power consumption.

Thus, each display apparatus according to the foregoing exemplary embodiments can solve the problems that may arise when the display apparatus is in the shutdown state. However, the present invention is not limited to the exemplary embodiments described above. Alternatively, in yet other embodiments of the present invention, the display apparatus may have configurations according to some or all of the first, second and third embodiments, thereby preventing the sticking phenomenon, the wasteful power consumption, and a user's confusion.

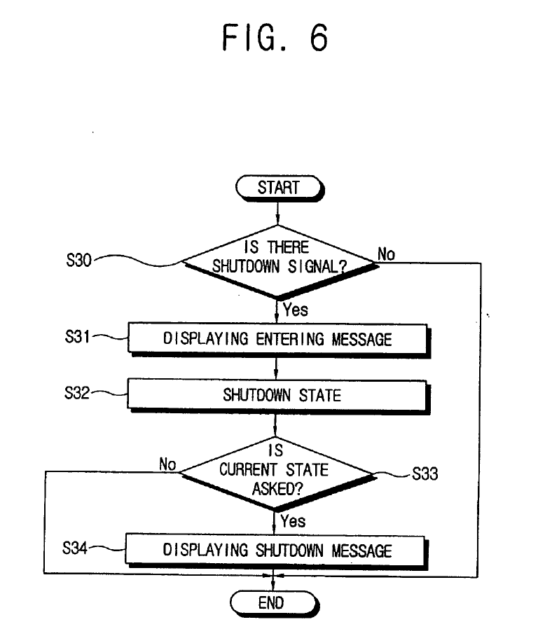

Hereinbelow, a control flowchart of the display apparatus according to the third embodiment of the present invention will be described with reference to FIG. 6. At operation S30, the microcomputer 66″ determines whether the computer main body outputs the shutdown signal. When the shutdown signal is output, the microcomputer 66″ controls the OSD generator 40″ at operation S31 to display the entering message to inform a user that the display apparatus is entering the shutdown state. Preferably, the entering message disappears after a lapse of a predetermined period. Thereafter, while in the shutdown state wherein the display apparatus is displaying a still picture, the microcomputer 66″ determines at operation S33 whether a user asks about the current state of the display apparatus through the key input part 50. When it is determined that a user asks about the current state of the display apparatus through the key input part 50, the microcomputer 66″ controls the OSD generator 40″ to display the shutdown message to inform a user that the display apparatus is in the shutdown state. Preferably, the shutdown message may include the time (e.g., 1:05) that has elapsed since the display apparatus has entered the shutdown state.

Thus, the display apparatus according to the third embodiment of the present invention displays the shutdown entering message when it receives the shutdown signal from the computer main body and enters the shutdown state, during which the still picture is displayed on the basis of the frame information stored in the frame buffer 36. Thereafter, when a user asks about the current state of the display apparatus, the display apparatus displays the shutdown message, thereby preventing a user from being confused as to the operation being performed.

As described above, the display apparatus according to the embodiments of the present invention prevent the image sticking phenomenon while the display apparatus continuously displays the still picture in response to the shutdown signal transmitted from the computer main body. Further, the display apparatus according to the embodiments of the present invention not only provide various messages to prevent a user from being confused while the display apparatus continuously displays the still picture in response to the shutdown signal transmitted from the computer main body, but also directs the apparatus to enter a power saving mode after a lapse of a predetermined time to reduce the wasteful power consumption.

Accordingly, the present invention provides a display apparatus which can decrease an image sticking phenomenon arising in a shutdown state while displaying a still picture as a shutdown signal is transmitted from a computer main body to the display apparatus, reduce wasteful power consumption, and offer various messages to prevent a user from being confused as to the operation being performed.

Although a number of exemplary embodiments of the present invention have been shown and described herein, it will be appreciated by those skilled in the art that changes may be made in these embodiments without departing from the principles and spirit of the invention, the scope of which is defined in the appended claims and their equivalents.

What is claimed is:

1. A display apparatus for communicating with a computer main body through a digital packet video link (DPVL) system, the display apparatus comprising:
a video signal processor to process a video signal output from a computer main body into a displayable video signal;
a frame buffer to store frame information corresponding to the video signal; and
a controller to control the video signal processor to display a picture based on the frame information stored in the frame buffer when a predetermined shutdown signal is output from the computer main body, and change the picture on the basis of the stored frame information when a predetermined period has elapsed after receiving the shutdown signal.

2. The display apparatus according to claim 1, wherein the controller is further programmable to:
control the video signal processor to display the picture based on the frame information stored in the frame buffer when the predetermined shutdown signal is output from the computer main body; and
move the picture by a predetermined width when a predetermined period has elapsed after receiving the shutdown signal.

3. The display apparatus according to claim 2, further comprising:
a key input part to allow a user to input a key; and
an on screen display (OSD) generator to generate a position movement menu allowing a user to select a position movement function for the picture, and to further allow a user to set the predetermined period for implementing the position movement function,
wherein the controller is further programmable to control the OSD generator to display the position movement menu when the position movement function is selected through the key input part, and store setting information that is set through the position movement menu by manipulating the key input part.

4. The display apparatus according to claim 3, wherein the controller is further programmable to:
control the video signal processor to move the position of the displayed picture by a predetermined width after a lapse of the predetermined period;
count the predetermined period; and
control the video signal processor to move the position of the displayed picture again after a lapse of the predetermined period.

5. The display apparatus according to claim 1, wherein the controller is further programmable to:
control the video signal processor to display the picture based on the frame information stored in the frame buffer when the shutdown signal is input; and
blink the displayed picture per a predetermined cycle after the predetermined period has elapsed.

6. A display apparatus for communicating with a computer main body through a digital packet video link (DPVL) system, the display apparatus comprising:
a video signal processor to process a video signal output from a computer main body into a displayable video signal;
a frame buffer to store frame information corresponding to the video signal;
a power supply to supply power to the display apparatus; and
a controller to control the video signal processor to display a picture based on the frame information stored in the frame buffer when a predetermined shutdown signal is output from the computer main body, and control the power supply to interrupt the power supplied to the display apparatus when a predetermined period has elapsed after receiving the shutdown signal to enter a power saving mode.

7. The display apparatus according to claim 6, further comprising:
a key input part to allow a user to input a key; and
an on screen display (OSD) generator to generate a power saving function menu allowing a user to select the power saving mode, and to further allow a user to set the predetermined period for implementing the power saving mode,
wherein the controller is further programmable to control the OSD generator to display the power saving function menu when the power saving mode is selected through the key input part, and store setting information that is set through the power saving function menu by manipulating the key input part.

8. The display apparatus according to claim 7, wherein the OSD generator is configured to:
generate a message to indicate whether the display apparatus is in the shutdown state and inform a user of a time remaining before entering the power saving mode; and
the controller is further programmable to control the OSD generator to display the message when a query relating to a current state of the display apparatus is received through the key input part while the display apparatus receives the shutdown signal and displays the picture based on the frame information stored in the frame buffer.

9. A display apparatus for communicating with a computer main body through a digital packet video link (DPVL) system, the display apparatus comprising:
a video signal processor to process a video signal output from a computer main body into a displayable video signal;
a frame buffer to store frame information corresponding to the video signal;
an on screen display (OSD) generator to generate a shutdown message to indicate a shutdown state;
a key input part to allow a user to input a key; and
a controller to control the OSD generator to display the shutdown message when a query relating to a current state of the display apparatus is received through the key input part while the display apparatus receives the shutdown signal from the computer main body and displays a picture based on the frame information stored in the frame buffer.

10. The display apparatus according to claim 9, wherein the OSD generator is configured to:
generate a shutdown entering message to indicate entering the shutdown state; and
the controller is further programmable to control the OSD generator to display the shutdown entering message for a predetermined period of time when the shutdown signal is output from the computer main body.

11. A method for controlling a communication between a display apparatus and a computer main body through a digital packet video link (DPVL) system, comprising:
processing a video signal output from a computer main body into a displayable video signal;
storing frame information corresponding to the video signal; and
displaying a picture based on the frame information when a predetermined shutdown signal is output from the computer main body, and changing the picture on the basis of the stored frame information when a predetermined period has elapsed after receiving the shutdown signal.

12. The method according to claim 11, further comprising:
displaying the picture based on the frame information when the predetermined shutdown signal is output from the computer main body; and
moving the picture by a predetermined width when a predetermined period is elapsed after receiving the shutdown signal.

13. The method according to claim 12, further comprising:
generating a position movement menu for allowing a user to select a position movement function for the picture and for setting the predetermined period for implementing the position movement function; and
displaying the position movement menu when the position movement function is selected and storing setting information that is set through the position movement menu.

14. The method according to claim 13, further comprising:
moving the position of the displayed picture by a predetermined width after a lapse of the predetermined period;
counting the predetermined period; and
moving the position of the displayed picture again after a lapse of the predetermined period.

15. The method according to claim 11, further comprising:
displaying the picture based on the frame information when the shutdown signal is input; and
blinking the displayed picture per a predetermined cycle after the predetermined period has elapsed.

16. The method according to claim 11, further comprising:
interrupting a power supplied to the display apparatus when a predetermined period has elapsed after receiving the shutdown signal to enter a power saving mode.

17. The method according to claim 11, further comprising:
displaying a shutdown message when a query relating to a current state of the display apparatus is received while the display apparatus receives the shutdown signal from the computer main body and displays a picture based on the frame information stored.
